(19) United States
(12) Patent Application Publication
(10) Pub. No.: US 2007/0199222 A1
(43) Pub. Date: Aug. 30, 2007

(54) DISPLAY SUPPORT DEVICE

(76) Inventor: William F. R. Turner, Bolton (GB)

Correspondence Address: DARBY & DARBY P.C., P.O. BOX 770, Church Street Station, New York, NY, 10008-0770, US

(21) Appl. No.: 11/678,983

(22) Filed: Feb. 26, 2007

Related U.S. Application Data
(60) Provisional application No. 60/776,341, filed on Feb. 24, 2006.

(51) Int. Cl. G09F 15/00

(52) U.S. Cl. 40/607.02

(57) ABSTRACT

The present invention provides a display support device comprising a holder having a groove preferably shaped to receive a sign insert and a gasket having a tapered end, the gasket being connected to a portion of the inner surface of the groove. The gasket is preferably connected to the groove so as to project away from the connected portion of the groove's inner surface. Optionally, the groove can include a T-shaped slot on its inner surface, and the gasket can include a T-shaped end that can be inserted into the T-shaped slot of the groove. Furthermore, the holder can include one or more grooves each having at least one gasket, thereby enabling the holder to receive at least one insert in each respective groove.

### CLAIM OF PRIORITY

This application claims priority pursuant to 35 U.S.C. § 119 of Provisional Patent Application Ser. No. 60/776,341 entitled “Display Support Device,” filed Feb. 24, 2006, the entire disclosure of which is hereby incorporated by reference.

### FIELD OF THE INVENTION

This invention is directed to a device for holding signs. More particularly, this invention relates to a device for holding replaceable signs of the type wherein the sign needs to be changed or updated on a relatively frequent basis.

### BACKGROUND OF THE INVENTION

There are numerous situations in which sign systems must enable signs to be easily changed. For example, in restaurants, a sign holder may be used to retain a menu on a tabletop with the menu being changeable on a daily basis. The need for such signs arises in a multiplicity of different fields and there are many sign systems that facilitate frequent changes in the sign content.

One popular system which has been developed uses an extruded base, cut to an appropriate length, containing a slot into which a sign can be placed. A representative sample of such a sign is shown in FIG. 4.

In the foregoing and other similar systems, the holder contains a groove designed to receive sign inserts of a specific thickness. This can lead to problems when the substrates on which the signs are printed tend to vary in thickness. For example, acrylic sheets that are nominally 0.125″ thick may vary as much as twenty percent in either direction from that dimension. Hence, a groove designed to accept an acrylic sheet must be made oversized relative to the nominal thickness of the sheet to ensure that it will fit. This means that in many cases the acrylic substrate will be loose in the sign holder, in which case it may be necessary to secure the sign by means of an adhesive or by mechanical fasteners.

The present invention provides a sign holder of the type described wherein signs that vary in thickness can be tightly retained without resort to supplemental fastening needs such as adhesives, mechanical fasteners, shims or the like.

### SUMMARY OF THE INVENTION

In accordance with one aspect of the present invention, a display support device is presented. The display device includes a holder having a groove with an inner surface, the groove being preferably shaped to receive a sign insert. The display device farther includes a gasket having a tapered end and connected to a portion of the inner surface of the groove. The tapered end of the gasket preferably projects away from the connected portion of the groove's inner surface.

In accordance with a further aspect of the present invention the groove of the holder further includes a T-shaped slot on the inner surface and the gasket includes a T-shaped end. Optionally, the gasket can be connected to the groove by inserting the T-shaped end of the gasket into the T-shaped slot of the groove.

In accordance with yet a further aspect of the present invention, the holder can include one or more grooves each having at least one gasket. Thus, the holder can preferably receive at least one insert in each respective groove.

These and other aspects, features and advantages will be apparent from the following description of certain embodiments and the accompanying drawing figures.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements throughout the views and in which:

FIG. 1 is a cross sectional view of a sign holder in accordance with the invention;

FIG. 2 is a cross sectional view of a rubber gasket for use with the sign holder of FIG. 1;

FIG. 3 is a side view showing how the sign holder of FIG. 1 could be used as a vertical support for multiple sign inserts;

FIG. 4 is a side sectional view of a tabletop sign holder showing how the invention would be incorporated into the sign holder; and

FIG. 5 is a side sectional view showing how the sign holder of FIG. 1 could be used to support a sign on a horizontal surface such as a tabletop or the like.

### DETAILED DESCRIPTION OF CERTAIN PREFERRED EMBODIMENTS

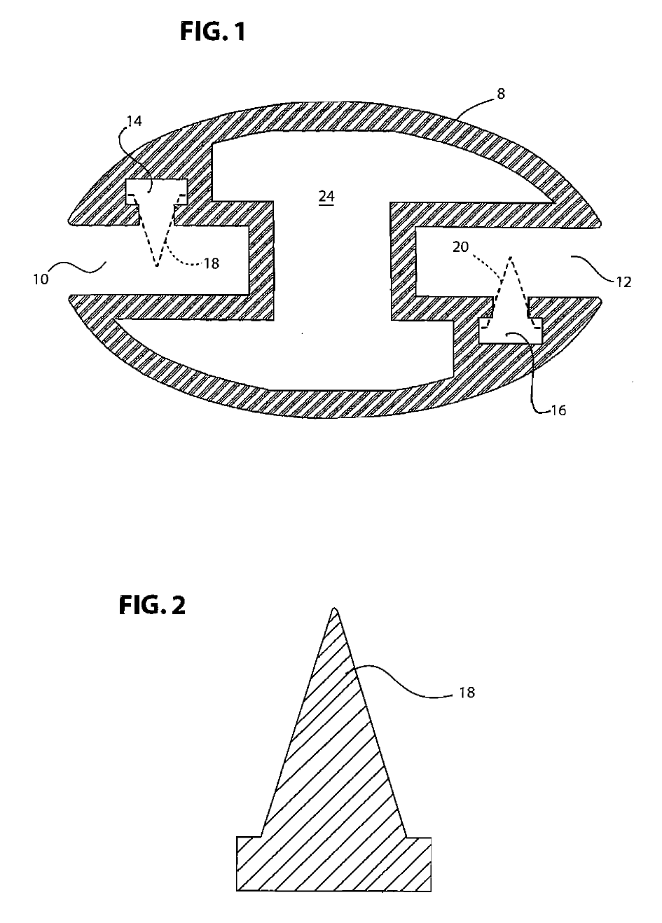

A cross sectional view of a sign holder in accordance with a preferred embodiment of the invention is shown in FIG. 1. In the preferred embodiment, the sign holder 8 is extruded. The extrusion may be metallic, for example aluminum, or a suitable plastic material such as polyvinylchloride. In FIG. 1 the extrusion is generally oval shaped and includes opposing grooves 10 and 12.

As explained in further detail below, the holder 8 may receive separate sign inserts, or one of the two grooves 10 and 12 may receive a mounting plate or similar device so that the holder 8 can be supported on a horizontal surface.

In the illustrated embodiment, grooves 10 and 12 each include a T-shaped slot 14 and 16, respectively, which are formed during extrusion of the holder 8. Complementary T-shaped rubber gaskets 18 and 20 (shown in FIG. 2 and in phantom in FIG. 1) are positioned within the grooves 14 and 16, respectively. The rubber gaskets 14 and 16 may be extruded and include a tapered extension (similar to a wiper blade) that extends into the grooves 10 and 12. When the edge of a sign insert (not shown in FIG. 1) is inserted into the groove 10, the rubber gasket is deflected to accommodate the insert but the resistance is such that the insert is held securely in place regardless of normal variations in thickness. The resistance, however, can be overcome by applying a force to the sign insert to pull it from the groove or by sliding it to one side so that it can be removed and replaced by another insert.

The rubber gaskets 18 and 20 are inserted into the T-shaped grooves 14 and 16 by sliding. The use of a lubricant such as talcum powder facilitates insertion.

A key feature of the holder is that it is designed to accept rigid and semi-rigid materials of varying thicknesses. It not only accepts typical production variances from a nominal thickness such as ⅛″ but it can also accept inserts of different nominal thicknesses altogether. For example, the holder may be ideally suited for ⅛″ material but it can be designed to accommodate sign inserts with a nominal dimension of 1/16″ to ¼″ Obviously, the holder 8 may be of any length depending on the size of the sign insert(s) it is designed to support.

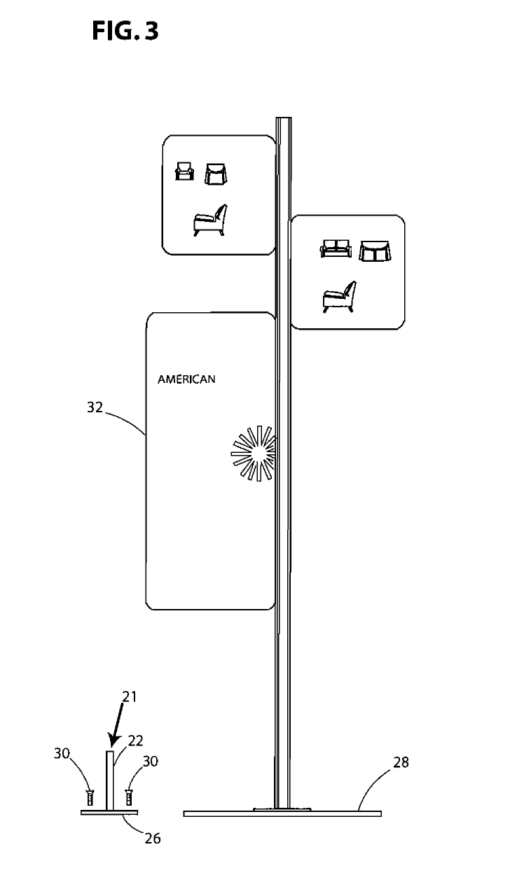

A sign holder according to the invention can be used in vertical, horizontal or angled positions. FIG. 3 shows an oval extrusion standing vertically as a free standing unit. One way this can be done is to provide a special footing plate 21 which includes a vertical post 22 that slides into the central opening 24 in extrusion 8. The post 22 is attached to a horizontal disk 26 which can be screwed onto a base plate 28 by screws 30. The sign holder 8 can then be placed over the footing plate 21 and any of a multiplicity of different signs 32 inserted into the grooves 10 and 12 where they will be retained firmly in place by the rubber gaskets 18 and 20.

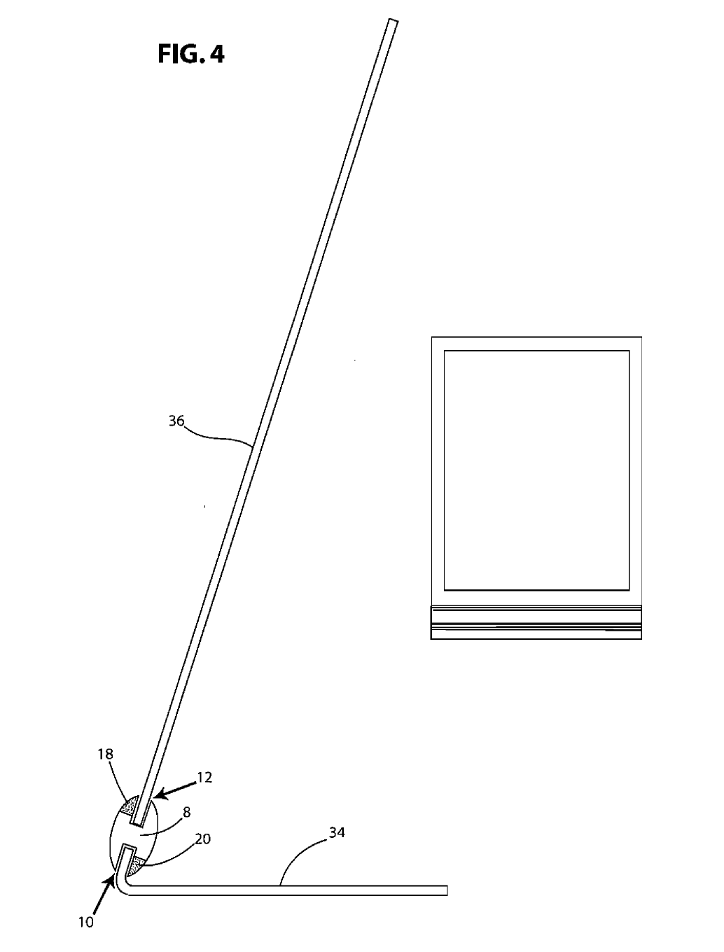

In FIG. 4 a bent base panel 34 is inserted into one of the grooves, for example groove 10 supporting the holder 8 at an angle relative to the base panel. A sign insert 36 can then be inserted into the opposite groove 12. The rubber gaskets 18 and 20 firmly retain the base and sign insert as explained above.

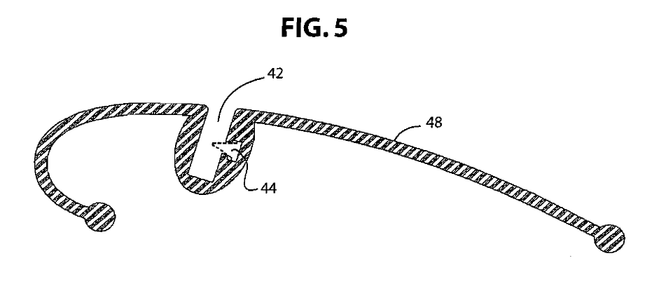

FIG. 5 is a side sectional view showing the profile of a sign holder sold under the trademark AEROLINEA™ by Visual Graphics Systems, Inc. The holder 40 is an aluminum extrusion and includes a groove 42 for receiving a sign insert. In this case a single T-shaped slot 44 receives the rubber gasket (shown in phantom lines) for retaining a sign insert (not shown) inserted into the groove 42.

While the invention has been described in connection with a certain embodiment thereof and in relation to a particular environment, the invention is not limited to the described embodiments and environments but rather is more broadly defined by the recitations in the claims below and equivalents thereof.

I claim:

1. A display support device comprising:
a holder including a groove having an inner surface, the groove being shaped to receive a sign insert; and
a gasket having a tapered end and connected to a portion of the inner surface of the groove such that the tapered end of the gasket projects away from the connected portion of the groove's inner surface.

2. The display support device of claim 1, wherein:
the groove further has a T-shaped slot on the inner surface,
the gasket includes a T-shaped end, and
the gasket is connected to the groove by inserting the T-shaped end of the gasket into the T-shaped slot of the groove.

3. The display support device of claim 1, wherein the T-shaped end of the gasket is opposite the tapered end of the gasket.

4. The display support device of claim 1, wherein the T-shaped end of the gasket is substantially triangular.

5. The display support device of claim 1, wherein the holder comprises an extrusion.

6. A display support device comprising:
a base;
a holder connected to the base and including a first and second groove each having a respective inner surface and shaped to receive a respective insert; and
a first and second gasket, each having a tapered end and connected to a portion of the inner surface of the respective first and second groove such that the tapered end of the gasket projects away from the connected portion of the respective groove's inner surface.

7. The display support device of claim 6, wherein the base includes a panel having a support end and a mounting end inserted into one of the first and second groove of the holder, the panel being bent at an angle defined between the support end and the mounting end so as to support the display device.

8. The display support device of claim 6, wherein:
the first and second groove each include a T-shaped slot on their respective inner surfaces,
the first and second gasket each include a T-shaped end, and
each of the first and second gasket is connected to the respective first and second groove by inserting the T-shaped end of the respective gasket into the T-shaped slot of the respective groove.
